(19) United States
(12) Patent Application Publication
(10) Pub. No.: US 2006/0150489 A1
(43) Pub. Date: Jul. 13, 2006

(54) Protection of germinating seed and pills containing pesticides

(76) Inventors: Robert Jean Legro, Enkhuizen (NL); Sijbert Honkoop, Maasdijk (NL)

Correspondence Address: Gary M. Nath;NATH & ASSOCIATES PLLC, 6th Floor, 1030 15th Street, N.W., Washington, DC, 20005, US

(21) Appl. No.: 11/295,485

(22) Filed: Dec. 7, 2005

Related U.S. Application Data
(63) Continuation-in-part of application No. 10/765,475, filed on Jan. 28, 2004, now Pat. No. 7,003,914.
Application No. 10/765,475 is a continuation of application No. 09/806,949, filed on Apr. 3, 2001, now abandoned.
Application No. 09/806,949 is a continuation of application No. PCT/NL00/00523, filed on Jul. 24, 2000.

(30) Foreign Application Priority Data
Aug. 26, 1999 (NL) 1012918

(51) Int. Cl. A01C 1/06

(52) U.S. Cl. 47/57.6

(57) ABSTRACT

The invention relates to an active-ingredient-containing pellet comprising an inert core and at least one active ingredient, wherein said active ingredient is advantageous for a plant seed or a plant. The invention also relates to a seed-containing pellet and a method for improving the germination of a seed-containing pellet.

The present invention relates to a method for the protection of germinating seed coated with pesticide.

Such a method is known in the field. Usually pesticides, such as, for example insecticides and fungicides are incorporated in the coatings of pelleted seeds.

The problem with many pesticides is that they can be rather phytotoxic for the germinating seed to which the pesticide is applied. One reason for this is the high dosage in which the pesticide often must be applied to afford adequate protection against the pest to be fought. The negative effect may vary from retarded germination to abnormal seedlings, or even to a total lack of germination of part of the seeds. Of course, the degree in which germination may be affected so negatively depends also on the type of pesticide, the seed species, the sensitivity of the variety, the vigour of the seed batch, and the environmental conditions during germination and emergence of the treated seed.

By covering the seed with a coating, the negative effect of the pesticide on the seed can be limited to some extend. For instance, the seed may be coated (pelleted) with a relatively thick layer of inert material on which the pesticide is applied in such a way that the pesticide is not directly in contact with the seed.

However, a further disadvantage of this method of pelleting is that at high dosages such a coating affords insufficient protection against the possible phytotoxic effect of the pesticide. Furthermore, due to the high dosages the coating's physiochemical properties may be changed significantly, indirectly producing a negative effect due to a change in the oxygen/water balance in the coating.

The present invention has the aim to avoid these disadvantages. This aim is achieved according to the present invention by simultaneously sowing seed-containing pellets and pesticide-containing pellets as separate pellets.

Because the seed germ and the pesticide are incorporated in separate pellets, the seed in the seed-containing pellet can germinate and grow before it comes into contact with the pesticide which will be released from another pellet. Thus during the most vulnerable stage, the moment of germination, there is no contact yet with the pesticide.

It is noted that in the present invention the term pesticide-containing pellets also includes film-coated inert cores (see example 3).

According to a preferred embodiment of the invention, the pesticide-containing pellets have substantially the same size and shape as the seed-containing pellets.

Since the pesticide-containing pellets are substantially the same size as the seed-containing pellets, it is thus possible with precision sowing machinery to sow one pesticide-containing pellet per plant. Thus in a simple way both sub- and overdose can be effectively avoided.

According to a preferred embodiment of the invention the pesticide-containing pellets comprise a pesticide dosage which is sufficient for one seed germ.

Thus unnecessary waste of the expensive pesticide is avoided, and furthermore there is the least possible impact on the environment.

According to another aspect of the method of the present invention, the pesticide-containing pellets contain a filler material.

By supplementing the exact dosage of pesticide with an appropriate amount of filler material, the size of the pesticide-containing pellet can be adapted to that of the seed-containing pellet.

According to an advantageous embodiment of the invention, both pesticide- and seed-containing pellets have a substantially uniform diameter ranging from of 0.5-5 mm.

The invention also relates to a pesticide-containing pellet for use in combination with a seed-containing pellet.

By sowing pellets having the same shape and size, an optimal sowability with precision sowing machines can be achieved.

According to the invention, the pesticide in the pesticide-containing pellet may be, for example, acaricides or miticides, bactericides, fungicides (e.g. Apron, Maxim, Thiram), herbicides, insecticides (e.g. Rovral® (Bayer), Gigant®, Tracer® (DowElanco), Gaucho®, Poncho®, Calypso® (Bayer), Cruiser® (Syngenta) Oncol® (Otsuka Chemical), Mundial® (BASF), Birlane® (Cyanamid) etc.), molluscicides, nematicides Avicta® (Syngenta), bird repellents, ant repellents and rodenticides, but also growth hormones, nutrients (micro and or macro), germination stimulants, micro organisms, pheromones, biological preparations, plant metabolic regulator, plant strengtheners, gene inducers etc.

All types of filler material commonly used in the seed coating business can be used such as, for example, clay, perlite, diatomaceous earth, quartz, cellulose, vermiculite, mica, etc.

Naturally the pesticide-containing pellet may be produced in any desired shape and size depending on the seed-containing pellets to be sown at the same time.

The core of the pesticide-containing pellet according to the invention may be inert, for example, a glass-bead, perlite, plastic, pumice or any other suitable material. If desired however, it is also possible to use killed, non-germinating seed (for example killed by heat treatment, gamma rays, microwave etc.) or other biodegradable organic material which has no detrimental effect on the seed germination.

Optionally according to the invention, a substance may be added to the pesticide-containing pill to regulate the release of the pesticide.

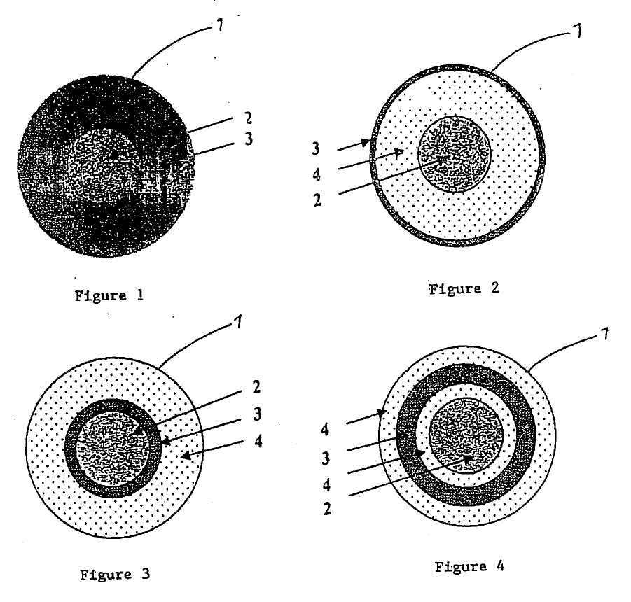

The present invention will now be further elucidated with reference to a number of exemplary embodiments. FIGS. 1-4 show alternative embodiments of a pesticide-containing pellet according to the invention.

FIG. 1 shows a pesticide-containing pellet 1 with a core 2, which core is surrounded by the active material 3.

FIG. 2 shows a pesticide-containing pellet 1 with a core 2, which core 2 is surrounded by a filler 4 provided with a coating of active material 3.

FIG. 3 shows a pesticide-containing pellet 1 with a core, core 2 is surrounded by an active material 3 provided with a coating of filler 4.

FIG. 4 shows a pesticide-containing pellet I with a core 2, which core is covered successively with a layer of filler 4, a layer of active material 3 and a coating of filler 4.

Naturally the pesticide-containing pellets may have any shape as long as this shape substantially resembles the shape of the seed-containing pellets.

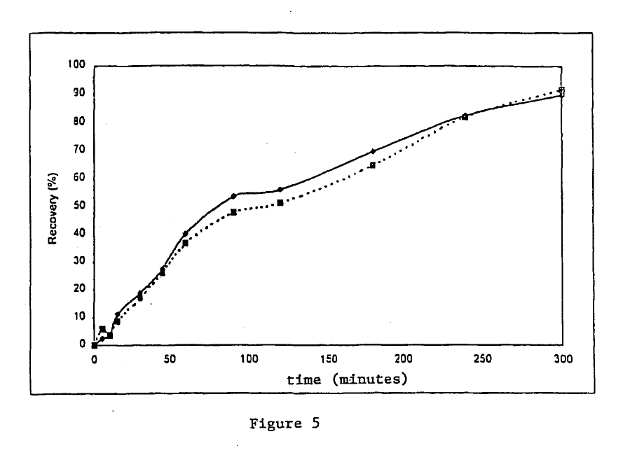

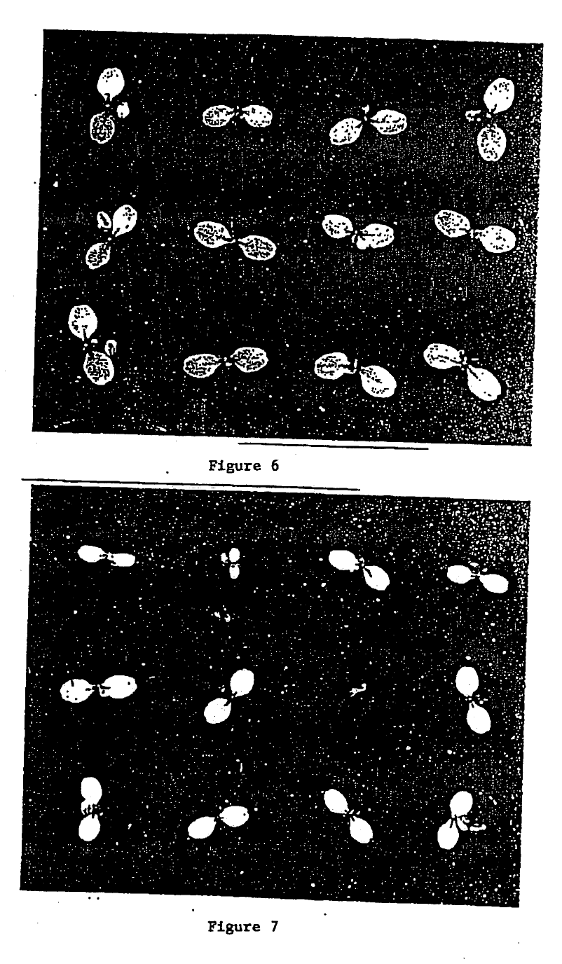

FIG. 5 shows a graph which illustrates the release of active component from a (viable) seed-containing pellet according to the prior art (solid line) in comparison with a pellet according to the present invention (dotted line).

FIG. 6 shows germinated lettuce seedlings from seed-containing pellets sown separately but simultaneously with pesticide-containing pellets (present invention).

FIG. 7 shows germinated lettuce seedlings from pellets containing both seed and pesticide (prior art).

In yet another embodiment, the invention provides an active-ingredient-containing pellet comprising an inert core and at least one active ingredient, wherein said active ingredient is advantageous for a plant seed or a plant. Such an active-ingredient-containing pellet is, as will be explained in more detail later, combined in the field or in a greenhouse with a seed-containing pellet or a true seed. The active-ingredient-containing pellet is also combined with a seedling or a (more mature) plant or with a (potato) tuber or a cutting or a rootstock or a flower bulb. In case of pelleted of true seed, said seed may be primed or non-primed.

The terms pesticide-containing pellet, active-ingredient-containing pellet, dummy pellet or dummy pill and smart pellet or smart pill will be used interchangeable herein.

An inert core is typically composed of a material that does not influence (in any way) the (germinating) seed, seedling, plant or any plant part (such as a tuber). Such an inert core has preferably one or more of the following features: the inert core is not a source of nutrients for micro-organisms in general and more specific not for (plant) pathogens and/or the inert core does not contain any (plant) pathogen and/or the inert cores in a particular batch have a certain extent of uniformity and/or the inert core must not be able to have a chemical interaction with the active-ingredient or the seed (or seedling or plant(part)). The needed degree of uniformity depends on the to be produced pellet. In case of, for example, an active-ingredient-containing pellet as shown in FIG. 1, the core must have a high degree of uniformity, preferably above 90% and even more preferably above 95%. In case of an active-ingredient-containing pellet as shown, for example, in FIGS. 2-4, the uniformity of the core is of less importance, because the uniformity will be increased upon pelleting.

In a preferred embodiment, the inert core is a round structure of uniform size, but other shapes and structures with uniform size distribution are also used. An example is a glass bead with a diameter of 1 to 2 mm. However depending on the application (for example on the size of the seeds with which the active-ingredient-containing pellet will be used) also smaller beads (e.g. tobacco pellet) can be used or larger cores. In a more preferred embodiment, the inert core is porous.

The active-ingredient-containing pellet according to the invention comprises at least one active ingredient. Examples are already mentioned above and include acaricides or miticides, bactericides, fungicides (e.g. Apron, Maxim, Thiram), herbicides, insecticides (e.g. Rovral® (Bayer), Gigant®, Tracer® (DowElanco), Gaucho®, Poncho®, Calypso® (Bayer), Cruiser® (Syngenta) Oncol® (Otsuka Chemical), Mundial®, Regent® (BASF), Birlane® (Cyanamid) etc.), molluscicides, nematicides (Avicta(® (Syngenta), bird repellents, ant repellents and rodenticides, but also growth hormones, nutrients (micro and or macro), germination stimulants, micro organisms, pheromones, biological preparations, plant metabolic regulator, plant strengtheners, gene inducers etc.

The active ingredient in an active-ingredient-containing pellet may be evenly distributed in said pellet or it may be confined to a certain layer or it may be present on the outside of said pellet. In case of an active ingredient that is phytotoxic to a plant seed or a young seedling, the corresponding active-ingredient pellet preferably comprises an outer coating layer which prevents direct contact of the active ingredient with the plant or young plant seedling.

In a preferred embodiment, the active ingredient present on or in the active-ingredient-containing pellet is in a certain concentration detrimental for the seed or incompatible with an ingredient present on a seed-containing pellet or the active-ingredient is desiccation intolerant or the active ingredient is instable during storage or the release of active ingredient is too short when present on or in a seed-containing pellet.

It is clear to the skilled person that an active-ingredient-containing pellet can also comprise two or more active ingredients. Preferably, the ingredients are chosen such that they are compatible with each other.

In a preferred embodiment, the invention provides an active-ingredient-containing pellet comprising an inert core and at least one active ingredient, wherein said active ingredient is advantageous for a plant seed or a plant and wherein said active ingredient is phytotoxic in the effective amount for a plant seed. In such a case the needed effective amount of active ingredient is applied on or in an active-ingredient-containing pellet. However, it is also possible to apply part of the seed-phytotoxic active ingredient on or in an active-ingredient-containing pellet and to also apply part of said ingredient on a seed-containing pellet. In such a case the concentration of seed-phytotoxic active ingredient on the seed-containing pellet is chosen such that the phytotoxic effect is not present. The necessary effective amount of active ingredient is obtained by the combined presence of active-ingredient on one or multiple active-ingredient-containing pellet(s) and on one or multiple seed-containing pellet(s).

However it is also possible to split the effective amount of active ingredient over the seed-containing pellet and the active-ingredient-containing pellet because of specific availability of the active. The active ingredient in the active-ingredient-containing pellet can be released (for example controlled or delayed) in such a way (for example weeks after planting) which is not possible when the active ingredient is only applied in a seed-containing pellet.

In yet another embodiment, the invention provides an active-ingredient-containing pellet comprising a biodegradable core and at least one active ingredient, wherein said active ingredient is advantageous for a plant seed or a plant.

A biodegradable core is a core which in time is at least partly and preferably completely degraded, for example by the action of soil bacteria. Examples of a biodegradable core are a core of nitrogen or an alginate bead or a PLAGA core. In a preferred embodiment such a biodegradable core is a round structure, preferably of a uniform size and even more preferably such a core is porous. The desired degree of uniformity of such a biodegradable core is for example dependent on the type of prepared dummy pellet (see FIGS. 1 to 4).

A person skilled in the art is very well aware of methods for preparing an active-ingredient-containing pellet with standard know technology like film coating on rotostat equipment or in pan coat equipment or fluidbed systems with polymer systems such as starch, poly saccharides, polyvinyl alcohols, acetates, acrylates, polyurethanes etc. The active-ingredient containing pellet can be prepared with commonly known seed pelleting technologies with filler material commonly used in the seed coating business such as, for example, clay, perlite, diatomaceous earth, quartz, cellulose, vermiculite, mica, etc.

In a preferred embodiment, the invention provides an active-ingredient-containing pellet that allows precision sowing. It is getting more and more important in the agriculture to provide an active ingredient in a very precise amount, because providing too much active ingredient will unnecessary burden the environment and using not enough active-ingredient will result in loss of crop. The present invention allows such a precision sowing by applying the correct amount of active ingredient.

In another embodiment, the invention provides a seed-containing pellet comprising a seed, a coating and at least one active ingredient, which active ingredient is present in an amount of 1-100 % preferably 50-100% or even more preferably 100% of the total effective amount. In a preferred embodiment, said active ingredient is capable of at least in part inhibiting a seed-borne-disease pathogen and even more preferably said active ingredient is a fungicide.

In yet another embodiment, the invention provides a seed-containing-pellet comprising a seed, a coating and at least one active ingredient, which active ingredient is present in an amount of 0.1-50 % preferably 0.1-25% or even more preferably 0.1-10% of the total effective amount. In a preferred embodiment, said active ingredient is capable of at least in part inhibiting insect-pest. In a preferred embodiment, said active ingredient is an insecticide.

This part of the invention can be used for different purposes, one of them being the use of fungicides to combat seed-borne disease pathogens and one of the other purposes is the use of an active ingredient which in its total effective amount needed is phytotoxic but which at lower concentrations is tolerated by the seed (for example an insecticide).

In respect of fungicides used to combat (at least in part) seed-borne disease pathogens it is noted that this is a particular advantageous embodiment, because seed-borne disease are now directly encountered and now the seeds do not have to be disinfected. For example, tomato seeds must be disinfected before they are being coated/pelleted. All crops that are sown directly into the field, for example onion, carrot, corn, sugar beets, sweet corn, wheat etc need fungicides to protect the seedling against seed born diseases. Examples of fungicides that can be used for this purpose are Thiram or Fludioxinyl, Captan, Maneb, Carboxin and PCNB. In a preferred embodiment said fungicide is present in an amount of 1-100 % preferably 50-100% or even more preferably 100% of the total effective amount.

In case of (almost all) insecticides the seed does tolerate a certain amount of said active ingredient without compromising the germination efficacy, but said seed does not tolerate the total amount needed to provide the desired effect of said active ingredient. In such a case the total amount of active ingredient is divided over a seed-containing pellet and (at least one) active-ingredient-containing pellet. Examples are Trigard (active ingredient cyromazine) on onions to combat onion maggots (onion fly) or Mundial (active ingredient fipronil) on Brassica to combat pests like cabbage fly or Force (active ingredient teflutrine) on onion. Even a nematicide like Avicta (active ingredient abamectine) can be used in this way to combat root nematodes on tomato and pepper roots. Preferably, such an insecticide is present on or in a seed-containing pellet in an amount of 0.1-50 %, preferably 0.1-25% or even more preferably 0.1-10% of the total effective amount. The remaining amount is present on or in an active-ingredient-containing pellet.

An active-ingredient-containing pellet or a seed-containing pellet according to the invention may further be provided with at least one component capable of regulating the release of said at least one active ingredient. Such a component is used to release at least one active ingredient at a desired time point. Different active ingredients may call for a different release time. For example, if at least one of the active ingredients is a micronutrient that is needed for or improves flower- and/or seed development such an active component is preferably released from the active-ingredient-containing pellet at a time point late in the development of the corresponding plant. Or if the active ingredient is a macronutrient such as phosphate, this is preferably released at the beginning of the plant growth/development. The choice of release of a pesticide largely depends on the type of pest or disease that needs to be encountered. If the pest is active in the early stages of plant growth, the pesticide is preferably released at an early time point and if the pest is active in later stages of plant growth, the pesticide is preferably released at a later time point.

The skilled person is aware of the fact that different types of release patterns can be obtained by using the appropriate components. Release patterns such as a burst or a delayed or a slow or a controlled or a sustained or an extended release are feasible. The different release patterns are typically defined as follows
lag burst is defined as initially little or no release followed in time by a sudden strong release over a short time period
delayed or sustained is defined as showing a release pattern like not-delayed but the start of the release is postponed
slow is defined as from the start a very gradual release, typically over a long time period
controlled is defined as release which is manipulated according to desired levels over a desired time period

Examples in respect of different release patterns are provided herein within the experimental part. Preferably the release is such that the active ingredient is released at a time point at which a seed or a plant is in need of said active ingredient.

The released active ingredient may originate from core (in case of for example a porous (inert) core) or from the coating around said core. Moreover, if more than one (for example 2 or 3) active ingredients are present on an active-ingredient-containing pellet or on a seed-containing pellet, said active ingredients may be coated/pelleted on said pellets in different layers with different release patterns. For example, an active-ingredient-containing pellet comprising at least 2 pesticides, one of the pesticides is needed during seed germination and the second one three weeks later after development of a plant. The pellet then comprises at least two release layers: one which releases the first pesticide during germination followed by seedling establishment and the other one releases the second pesticide approximately 3 weeks later. It is clear to a skilled person that the same effect is also obtained by providing two separate active-ingredient-containing pellets, each one with its one active ingredient and it's own release pattern.

Moreover, the release of a pesticide may be curative or precautionary.

It is clear to the skilled person that a component used to establish a certain release pattern is carefully selected not only in respect of the appropriate component but also in respect of the concentration as well as in respect of layer thickness. Components used can be from the groups: ethyl acrylate copolymers (Eudragit,Degussa), poly-urethanes, polyvinylacetates polymers and copolymers, poly lactic acids, poly acrylamide-based polymers, hydrogels made by essential anhydrous polymerisation reaction etc.

The release coatings are provided on a pellet with standard coating/pelleting techniques which are already mentioned above.

Besides the fact that a seed-containing pellet or active-ingredient-containing pellet may be provided with a component that regulates the release of at least one active ingredient, the invention further provides a seed-containing pellet or active-ingredient-containing pellet which has further been provided with at least one type of super-absorbent-polymer (SAP). Examples of a SAP are sodium polyacrylates, potassiumpolyacrylates, crosslinked poly acrylates, modified cellulose esthers and starchcrafted cross-linked poly acrylates. Although seed coating and/or pelleting techniques are normally performed in an aqueous solution it is also possible to coat/pellet seeds based on methods that involve the used of solvents.

In case it is necessary to disinfect seeds before subjecting them to a coating/pelleting method, such disinfection can be carried out by methods known by the skilled person, such as chemical or biological disinfection or hot water treatment or steam treatments.

Although an active-ingredient-containing pellet is preferably applied together with a seed-containing pellet, an active-ingredient-containing pellet may also used together with a plant part such as a potato tuber, flower bulb or with a plant cutting or with a true seed or with a rootstock. Moreover, an active-ingredient-containing pellet according to the invention may also be used when a plant is transferred from one growing medium to another growing medium (for example from soil type a to soil type b).

In another embodiment, the invention provides a method for improving the germination of a seed-containing pellet, comprising applying 1 to 10 active-ingredient-containing pellets with at least one seed-containing pellet to soil. In yet another embodiment, the invention provides a method for improving the germination of a seed-containing pellet, comprising applying at least one active-ingredient-containing pellet with at least 1 to 10 seed containing pellets. Instead of a method for improving the germination of a seed-containing pellet, such a method is also used to improve the germination of a true seed or to improve the growth of a rootstock or a tuber or a flower bulb or a plant cutting. In view of the earlier made remarks it is clear that such methods can also be used to improve the growth of a plant. In such a case one plant is provided with 1 or multiple active-ingredient-containing pellets for example by putting said pellets in the soil with the plant.

In a preferred embodiment, said seed-containing pellet is a multiseed. Such a multiseed may be composed of a couple of seeds that form one clump of seeds or such a multiseed may comprise a couple of seeds arranged around for example an inert core or a couple of smaller seeds arranged around a larger (killed) seed.

If more than one active-ingredient-containing pellet is used per seed-containing pellet the active-ingredient-containing pellets may be identical or different (for example different in the amount of a particular pesticide or different in the kind of active ingredient, for example, one pellet comprising a pesticide and another comprising a hormone etc). Another example wherein one would use different active-ingredient-containing pellets is if for example two active ingredients are incompatible (and can thus not be present on one and the same pellet) or if different release patterns are desired.

One of the advantageous of these methods is a large amount of flexibility. For example the choice for the amount of active-ingredient-containing pellets is made on the actual pest pressure; pelleted seeds are prepared in advance and dependent on the actual pest pressure it is decided how many pesticide-containing pellets are applied The invention further provides a method according to the invention, wherein at least part of the active-ingredient-containing pellets is applied after applying a seed-containing pellet or wherein an active-ingredient-containing pellet is applied on top of the soil. This again introduces a lot of flexibility because an active-ingredient-containing pellet can be applied simultaneous with the seed-containing pellet as well as prior to sowing or after sowing of the seed-containing pellet. Moreover, depending on the desired use of the active-ingredient-containing pellet it may be placed in the soil as well as on top of the soil. For example, an active-ingredient-containing pellet comprising as an active ingredient a snail or bird repellent is placed on top of a field. Preferably, such an active-ingredient-containing pellet has the appearance of a seed pellet.

The invention will now be elucidated with reference to a number of non-limiting examples.

### EXAMPLE 1

One million lettuce seeds (lactuca sativa) in a batch weighing 1.10 gram per 1 thousand grains were killed by means of gamma-rays (40 kGy). The batch was pelleted according to the standard procedure, using a standard 100 cm diameter pelleting-pan (Vingerlings Machinefabriek b.v., Rotterdam, Netherlands).

This process entailed the alternating addition of coating material (C-1, Incotec) and binding solution (Sol-1, Incotec) providing pellets having a uniform shape and size (3.25-3.5 mm slot screen).

Then the pellets were dried for 1.5 hours at 40° C. In a fume-cupboard, at room temperature, 2000 ml of a commercial coating-formulation (Disco Color Red L083) was mixed with 1143 g of insecticide powder Gaucho 70 WS® (Bayer) and 2660 ml water. The batch of 1 million dried pellets was processed in a Pancoater (Ramacota 36) of a diameter of 36 inches according to the standard process.

This process entailed that during the entire process (12 0 min.) the coating-mixture was evenly and slowly distributed over the pellets while continuously drying (drying temperature=55° C.), resulting in the pellets as described in FIG. 2. The insecticide is comprised in the thin film of coating on the outside of the pellet.

The above-mentioned pellets have a recovery of 98% (recovery measurements done by a HPLC) of the active ingredient imidacloprid, the active component (a.c.) of the Gaucho-formulation, measuring a distribution coefficient of variation of 10%.

The insecticide is released into the water from the produced Gaucho-pellets (800 g a.c./million pills) in the same way as from the pellets comprising both the seed and the Gaucho (800 gram a.c./million pellets) in the same pellet (see FIG. 5),

FIG. 5 shows the release into water of the active component from a viable seed-containing pellet according to the prior art (solid line) and from a pellet according to the invention (dotted line). Plotted are the recovery in % against time (minutes).

The seed-containing pellets and the Gaucho-containing pellets (800 gram a.c./million pellets) sown as separate pills (FIG. 6) germinate more evenly than the pellets that contain both live seed and Gaucho (800 g a. c./million pellets) in one pellet (see FIG. 7)

The above example is also applicable to other seed species, such as: Tobacco (Nicotiana tabacum) in the pellet size 1.75-2.00 mm with a dosis of 200 g imidacloprid/million pellets. Sugar beet (Beta Vulgaris) in the pellet size 3.75-4.50 mm with a dosis of 900 g imidacloprid/million pellets.

### EXAMPLE 2

From a batch of three million glass-beads pellets were produced according to the standard procedure. The batch was processed in a pelleting pan with a diameter of 100 cm (Vingerlings Machinefabriek b.v., Rotterdam, Netherlands). In this method the coating material (C-22, Incotec) and binding solution (Sol-1, Incotec) were added alternately in order to produce pellets of homogeneous size and shape (1.50-1.75 mm slot screen).

Subsequently, the pellets were dried at 60° C. for 45 minutes. In a fume-cupboard at room temperature 31.5 ml of a commercial coating formulation (Disco Color Red L083, Incotec) was mixed with 18.0 gram of insecticide powder Gaucho 70 WS® Bayer) en 10.4 ml of water. A batch of 90.000 dry pellets was placed in a ‘Rotostat coating machine’ with a diameter of 30 cm (Marline, Norfolk, England). The mixture of insecticide and coating formulation was applied by means of the standard ‘spinning disc’ (6 cm diameter). After 3 minutes process time, the mixture was distributed evenly over the pellets and the pellets were transferred to a standard pelleting pan. Alternately, finishing-material (F-13, Incotec) and binding solution (Sol-1, Incotec) were added in order to produce pellets of homogeneous size and shape (2.00-2.25 mm slot screen).

Then, the pellets were dried at a temperature of 60° C. for 45 minutes resulting in pellets as described in FIG. 4.

### EXAMPLE 3

In a fume cupboard at room temperature, 345 g of a commercial coating formulation (Disco L126, Incotec) is mixed with 107 g insecticide formulation Gigant 480FS (DowElanco) and 11.5 g fungicide solution Rovral Aquaflo (Bayer). A batch of 1495 gram cauliflower seeds (Brassica oleracea) with a seed-fraction of 1.50-1.75 mmR was killed by means of microwave (300 W, 45 min., Samsung M935). The batch was processed according to the standard procedure in a Pancoater (Ramacota-18) with an 18 inch diameter. This procedure entailed that during the entire process the coating formulation was slowly distributed over the seeds by means of an air spray gun while continuously drying (drying temperature=55° C/) resulting in film-coated seeds as described in FIG. 1. The insecticide is comprised in the thin layer of film coating on the outside of the ‘dead’ seed.

### EXAMPLE 4

We have produced smart pellets of dead Brassica seeds with 200 gram Gaucho 70WS (Bayer) per 100.000 pellets with standard seed coating equipment. These Brassica smart pellets have been film coated with several layers of a polymer system based on polylactic acids provided by Croda Bowmans Chemicals LtD. These smart pellets are tested in field trials by an experimental station (see example 5).

This experiment is designed to give some insight whether it is possible to control the release of imidacloprid with polylactic acid polymers. Moreover, will lag burst release of imidacloprid improve the control of trips in white cabbage?

The seeds were pelleted on a rotary coater. Rate of active ingredient is 140 g a.c./100.000 seeds.

The release of all smart pellet types is measured in water and during the plant raising stages by obtaining a sample from each smart pellet type. The field trials are performed by an experimental station (example 5).

| | | | Amount of |
|---|---|---|---|
| Object no | | | polymer |
| 81.13998.6001 | Control smart pellet | | |
| 81.13998.6002 | Smart pellet A | Thin layer | 1.42 mg/pellet |
| 81.13998.6003 | Smart pellet B | Medium layer | 1.94 mg/pellet |
| 81.13998.6004 | Smart pellet C | Thick layer | 2.69 mg/pellet |

The thickness of the layer is defined as the amount of polymer/pellet.

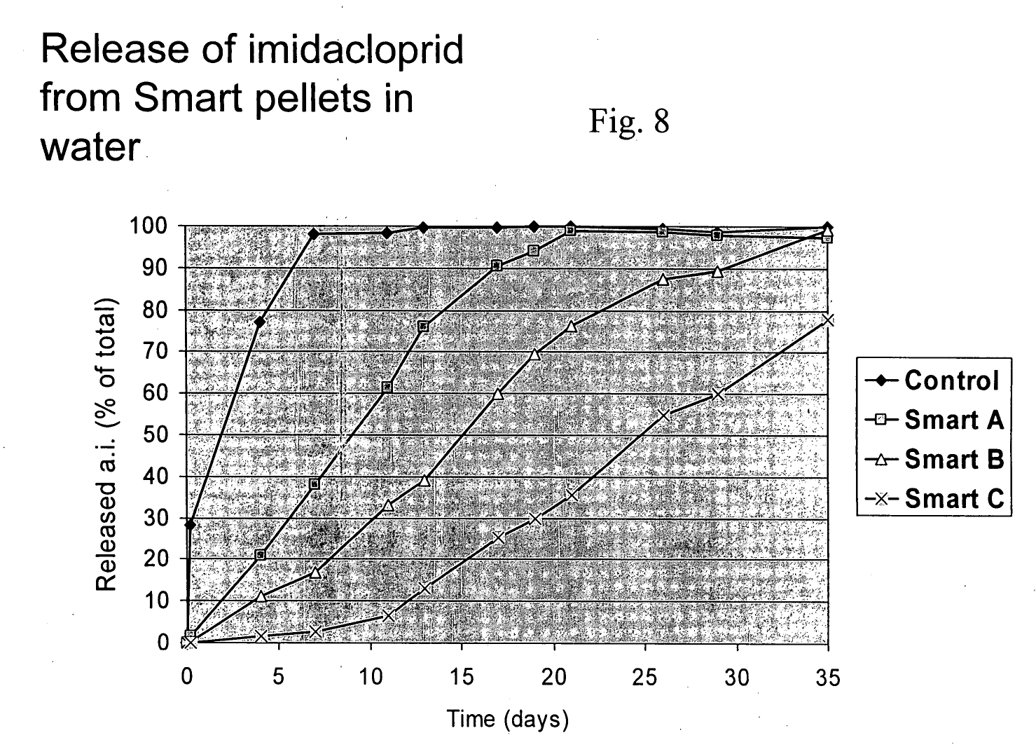

FIG. 8 discloses the release of imidacloprid from the dummy in water.

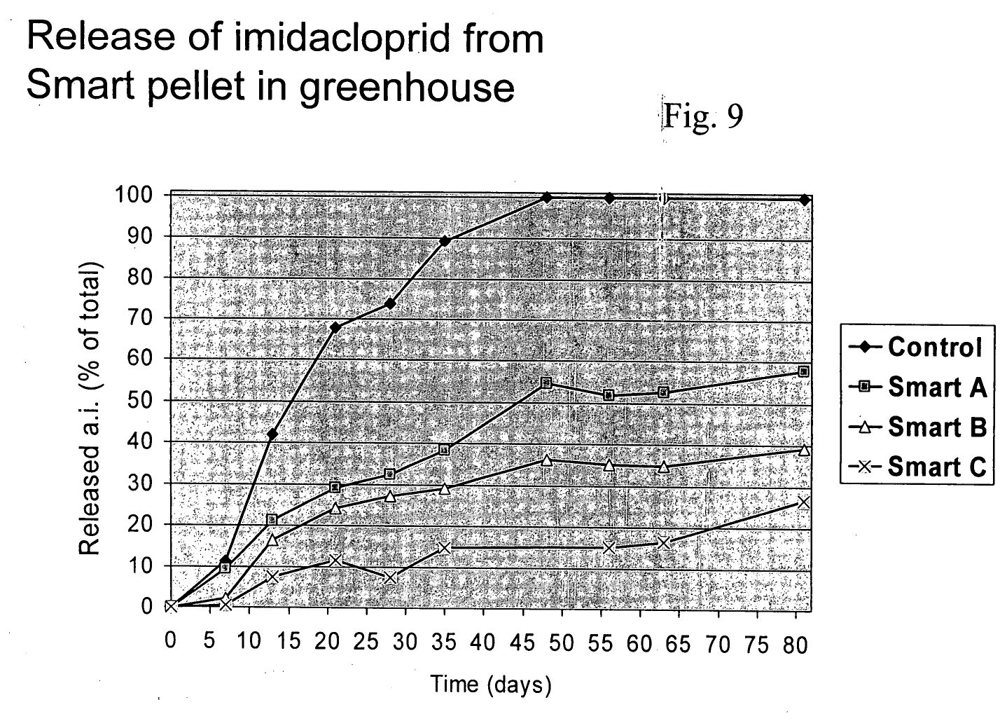

FIG. 9 discloses the release of imidacloprid from the dummy in the greenhouse at the plant raiser (first 4 weeks) followed by the release in the field.

It is clear from FIGS. 8 and 9 that the release of imidacloprid from the dummy pellets is slowed down with the used coating. With this technology it is feasible to release active ingredient during the complete growing season

This experiment was repeated and analogous results were obtained in the repetition.

### EXAMPLE 5

The efficacy of the imidacloprid pellets prepared in example 4 have been tested on their effect on the control of thrips in white cabbage.

The following object were tested and compared:

| | | Dose of Gaucho |
|---|---|---|
| code | object | (rate of active ingredient) |
| 1 | control | — |
| 2 | Gaucho seedcoating | 2 g / 1000 plants |
| | | (140 g a.i. / 100.000 seeds) |
| 3 | control + Gaucho dummy | 2 g / 1000 plants |
| | | (140 g a.i. / 100.000 seeds) |
| 4 | control + slow release type A | 2 g / 1000 plants |
| | | (140 g a.i. / 100.000 seeds) |
| 5 | control + slow release type B | 2 g / 1000 plants |
| | | (140 g a.i. / 100.000 seeds) |
| 6 | control + slow release type C | 2 g / 1000 plants |
| | | (140 g a.i. / 100.000 seeds) |

| | |
|---|---|
| Trial locatie | Experimental station |
| Cultivar | thrips sensitive variety |
| Sowing date | 20 Apr. 2005 |
| Planting date | 1 Jun. 2005 |
| Previous crop | Grass |
| (% lutum) | (20) |
| % organic | 5.9 |
| matter | |
| Fertilizer kg/ha | 270 kg N als KAS |
| reps | 4 |
| Herbicide use | Butisan S 2 l/ha and Centium CS 0.2 l/ha on 6 Jun. 2005 |
| yield | 7 Nov. 2005 |

| | Number of thrips per 5 heads | | | | | |
|---|---|---|---|---|---|---|
| treatments | 27 July | 9 August | 24 August | 9 Sept. | 23 Sept. | 13 Oct. |
| 1 untreated | 5.0 | 1.3 | 1.3 | 19.3c | 16.8 | 18.3 |
| 2 Gaucho | 5.3 | 1.5 | 0.8 | 12.5b | 15.3 | 19.8 |
| 3 Gaucho dummy | 4.3 | 0.5 | 0.0 | 9.5ab | 8.5 | 16.0 |
| 4 slow release A | 4.8 | 0.5 | 0.5 | 11.3ab | 14.0 | 25.0 |
| 5 slow release B | 3.0 | 0.3 | 0.5 | 13.8b | 8.0 | 17.0 |
| 6 slow release C | 3.8 | 1.8 | 1.5 | 7.0a | 9.0 | 12.5 |
| P- | 0.916 | 0.665 | 0.578 | 0.004 | 0.268 | 0.805 |
| Lsd | 4.8 | 2.3 | 1.9 | 5.3 | 9.7 | 18.7 |

Unfortunately, the pest pressure was (due to the weather) extremely low. The control without any pesticide had only 18 thrips per head at the end of the season, whereas in example 6 which had a better pest pressure the control head contained 48 thrips per head.

### EXAMPLE 6

In another experiment with the control of thrips in white cabbage, it was demonstrated that the use of more then one active-ingredient-containing pellet per one seed-containing pellet results in better control of pests. Moreover, this experiment also revealed the efficacy of one active-ingredient-containing pellet per seed-containing pellet. The setup of this trial was equal as described in example 5.

The table gives the results of this trial. The control in this trial had 48 thrips per head whereas the control of example 5 only had 18.

| | Imadcloprid | Number of thrips per 5 heads | | | |
|---|---|---|---|---|---|
| treatment | per plant | 13-July | 8-August | 7-Sep. | 13-Oct. |
| control | 0 mg | 1 | 0.3 | 16 | 48 |
| Seed treatment | 1.4 mg | 0 | 0 | 11 | 23 |
| Active in seed | | | | | |
| containing pellet | | | | | |
| one smart pellet | 1.4 mg | 0 | 0 | 8 | 14 |
| two smart pellets | 2.8 mg | 0.5 | 0 | 11 | 4 |
| Soil drench | 3.5 mg | 0 | 0 | 7 | 5 |

The data of this trial clearly show that already one smart pellet results in lower pest occurrence. The control of the pest could even be increased by using two smart pellets per plant. The rate of active ingredient was raised from 1.4 to 2.8 mg per plant which is still lower that the allowed soil drench application of 3.5 mg/plant, but the protection is similar.

The present invention is not limited to the embodiments mentioned in the above examples. They can be varied in many ways, all deemed within the scope of the appended claims.

1. Method for the protection of germinating seed coated with a pesticide, characterized in that seed-containing pellets and pesticide-containing pellets are sown as individual pellets at the same time.

2. Method according to claim 1, characterized in that the pesticide-containing pellets have substantially the same shape and size as the seed-containing pellets.

3. Method according to claim 1, characterized in that the pesticide-containing pellets comprise a dosis of pesticide that is sufficient for one seed germ.

4. Method according to claim 1, characterized in that the pesticide-containing pellets contain a filler material.

5. Method according to claim 1, characterized in that the pesticide-containing pellets and the seed-containing pellets have a substantially uniform diameter ranging from 0.5-5 mm.

6. Pesticide-containing pellet to be used in combination with a seed-containing pellet.

7. An active-ingredient-containing pellet comprising an inert core and at least one active ingredient, wherein said active ingredient is advantageous for a plant seed or a plant.

8. An active-ingredient-containing pellet according to claim 7, wherein said active ingredient is phytotoxic for a plant seed.

9. An active-ingredient-containing pellet comprising a biodegradable core and at least one active ingredient, wherein said active ingredient is advantageous for a plant seed or a plant.

10. A seed-containing pellet comprising a seed, a coating and at least one active ingredient, which active ingredient is present in an amount of 0.1-50%, more preferably 0.1-25% or even more preferably 0.1-10% of the total effective amount.

11. A seed-containing pellet according to claim 10, wherein said active ingredient is an insecticide.

12. A seed-containing pellet comprising a seed, a coating and at least one active ingredient, which active ingredient is present in an amount of 1-100 % preferably 50-100% or even more preferably 100% of the total effective amount.

13. A seed-containing pellet according to claim 12, wherein said active ingredient is a fungicide.

14. An active-ingredient-containing pellet comprising an inert core and at least one active ingredient, wherein said active ingredient is advantageous for a plant seed or a seed-containing pellet according to claim 10, further comprising at least one component capable of regulating the release of said at least one active ingredient.

15. A method for improving the germination of a seed-containing pellet, comprising applying 1 to 10 active-ingredient-containing pellets with at least one seed containing pellet to soil.

16. A method for improving the germination of a seed-containing pellet, comprising applying at least one active-ingredient-containing pellet with at least 1 to 10 seed-containing pellets.

17. A method according to claim 15, wherein said seed-containing pellet is a multiseed.

18. A method according to claim 15, wherein at least part of the active-ingredient-containing pellets is applied after applying a seed-containing pellet.

19. A method according to claim 15, wherein an active-ingredient-containing pellet is applied on top of the soil.

20. A method according to claim 15, wherein said active-ingredient-containing pellet is an active-ingredient pellet comprising an inert core and at least one active ingredient, wherein said active ingredient is advantageous for a plant seed or a plant.
